(19) United States
(12) Patent Application Publication
(10) Pub. No.: US 2026/0012848 A1
(43) Pub. Date: Jan. 8, 2026

(54) Quality of Service (QoS) Enhancements to Meet Delay Bound of Delay-Critical Applications

(71) Applicant: Apple Inc., Cupertino, CA (US)

(72) Inventors: Abdel Karim AJAMI, San Jose, CA (US); Anuj BATRA, Redwood City, CA (US); Brajesh K DAVE, Cupertino, CA (US); Chittabrata GHOSH, San Jose, CA (US); Jinjing JIANG, Campbell, CA (US); Mohamed ABOUELSEOUD, Burlingame, CA (US); Oren SHANI, Saratoga, CA (US); Yong LIU, Campbell, CA (US)

(21) Appl. No.: 19/257,704

(22) Filed: Jul. 2, 2025

Related U.S. Application Data
(60) Provisional application No. 63/667,235, filed on Jul. 3, 2024.

(51) Int. Cl. H04W 28/02; H04W 28/16

(52) U.S. Cl. CPC H04W 28/0278; H04W 28/16

(57) ABSTRACT

An apparatus configured to generate, for transmission to an access point (AP) under a Stream Classification Service (SCS) agreement, a request for a commitment for triggering beyond a minimum data rate specified in the SCS agreement based on a buffer status report (BSR), process, based on signaling received from the AP, one or more trigger frames pursuant to the commitment and generate, for transmission to the AP, data in response to the one or more trigger frames.

### PRIORITY/INCORPORATION BY REFERENCE

This application claims priority to U.S. Provisional Application Ser. No. 63/667,235 filed Jul. 3, 2024, and entitled “Quality of Service (QoS) Enhancements to Meet Delay Bound of Delay-Critical Applications,” the entirety of which is incorporated by reference herein.

### BACKGROUND

Multilink stations (STA) may connect to a wireless local area network (WLAN) via a multilink access point (AP) using, for example, links operating in the 2.4 gigahertz (GHz), 5 GHz and 6 GHz frequency bands. Currently, 802.11 standards organizations are considering enhancements for triggered uplink (UL) access for better Quality of Service (QoS) support.

802.11be introduced the Stream Classification Service with QoS Characteristics (SCS+QoS Char.) protocol to enable a client to request the AP to trigger the client for UL based on a minimum/maximum service interval and a minimum data rate. Requesting a large data rate on a long term may lead to unnecessary padding (dumping of bits) and power consumption. However, due to channel conditions or dynamic changes in the application data size with a variable bit rate codec during a QoS session, allocated UL resources may not be sufficient and may lead to a buffer build up. A temporary buffer build up requires more UL resources to be allocated by the AP to meet the delay bound. A client that is operating under Multi-User Enhanced Distributed Channel Access (MU EDCA) may not be able to access the channel at the proper time, and if the AP does not trigger the remaining buffered data, a client may fail the delay bound, causing a glitch in the data. The AP may use a large MU EDCA Timer that is much larger than the delay bound of the application. In this case, applications with tight delay bounds are more prone to such failures.

### SUMMARY

Some example embodiments are related to an apparatus having processing circuitry coupled to memory, the processing circuitry configured to generate, for transmission to an access point (AP) under a Stream Classification Service (SCS) agreement, a request for a commitment for triggering beyond a minimum data rate specified in the SCS agreement based on a buffer status report (BSR), process, based on signaling received from the AP, one or more trigger frames pursuant to the commitment and generate, for transmission to the AP, data in response to the one or more trigger frames.

Other example embodiments are related to an apparatus having processing circuitry coupled to memory, the processing circuitry configured to generate, in response to determining that a temporary data buffer build up has occurred, for transmission to an access point (AP) under a Stream Classification Service (SCS) agreement, a request for triggering beyond a minimum data rate specified in the SCS agreement, the triggering being before an upcoming service interval in order to satisfy a delay bound, process, based on signaling received from the AP, feedback in response to the request for triggering and generate, for transmission to the AP, data in response to the feedback.

Still further example embodiments are related to an apparatus having processing circuitry coupled to memory, the processing circuitry configured to process, based on one or more signals received from a client under a Stream Classification Service (SCS) agreement, a request for a commitment for triggering beyond a minimum data rate specified in the SCS agreement during the SCS agreement based on a reported buffer status report (BSR) and in response to agreeing to a commitment to provide triggering, generate one or more trigger frames pursuant to the commitment.

Additional example embodiments are related to an apparatus having processing circuitry coupled to memory, the processing circuitry configured to process, based on signaling received from a client under a Stream Classification Service (SCS) agreement, an indication that a temporary data buffer build up has occurred and a request for triggering beyond a minimum data rate specified in the SCS agreement, the triggering occurring before an upcoming service interval to satisfy a delay bound and, in response to the request for triggering, generate feedback configured to allow the client to transmit data in response to the feedback.

More example embodiments are related to a wireless communication system having a client and an access point (AP), wherein the client has transceiver circuitry to transmit to an access point (AP), under a Stream Classification Service (SCS) agreement, a request for a commitment for triggering beyond a minimum data rate specified in the SCS agreement based on a reported buffer status report (BSR) and the AP has processing circuitry configured to cause transceiver circuitry to transmit an indication to the client that the AP has accepted the commitment to provide triggering, and pursuant to the commitment, cause the transceiver circuitry to send a trigger frame to the client, wherein the processing circuitry in the client is configured to cause transceiver circuitry to transmit data in response to the trigger frame received from the AP.

Further example embodiments are related to a wireless communication system having a client and an access point (AP), wherein the client has processing circuitry that is configured to cause transceiver circuitry to transmit, in response to a determination that a data buffer build up has occurred for the client, a request to the AP, under a Stream Classification Service (SCS) agreement, for triggering beyond a minimum data rate specified in the SCS agreement, the triggering occurring before an upcoming service interval in order to meet a delay bound and the AP has processing circuitry to cause transceiver circuitry to send feedback to the client in response to the request for triggering, wherein the processing circuitry in the client is configured to cause transceiver circuitry to transmit data in response to and based on the feedback received from the AP.

### BRIEF DESCRIPTION OF THE DRAWINGS

FIG. 1 shows an example network arrangement according to various example embodiments.

FIG. 2A shows an example multilink device (MLD) according to various example embodiments.

FIG. 2B shows an example simplified block diagram of a WLAN Access Point (AP), according to various example embodiments.

FIG. 2C shows an example simplified block diagram of a wireless station, according to various example embodiments.

FIG. 3 shows an example timing diagram of transmissions between an access point (AP) MLD and a multilink station (STA) MLD illustrating how a STA (client) operating under MU EDCA has buffered data which will not be sent within the delay bound because an access point does not trigger additional resources for the remaining data in the station's buffer according to various example embodiments.

FIG. 4 is an example timing diagram of transmissions between an access point (AP) MLD and a multilink station (STA) MLD in an enhanced method of performing SCS to meet a delay bound according to various example embodiments.

FIG. 5 shows an example QoS Characteristics element with a new field (Dynamic Resource Allocation Enabled) according to various example embodiments.

FIGS. 6A and 6B are example timing diagrams of transmissions between an access point (AP) MLD and a multilink station (STA) MLD in another enhanced method of performing SCS to meet a delay bound according to various example embodiments.

FIG. 7 shows an example QoS Characteristics element with a new field (Dynamic Triggering Feedback Enabled) according to various example embodiments.

### DETAILED DESCRIPTION

The example embodiments may be further understood with reference to the following description and the related appended drawings, wherein like elements are provided with the same reference numerals. The example embodiments describe devices, systems, and methods to operate a wireless device in a more efficient manner by providing an enhanced method of performing a Stream Classification Service (SCS) to meet a delay bound so that a desired QoS may be met.

The example embodiments are described with regard to a Wireless Local Area Network (WLAN). A person of ordinary skill in the art would understand that WLAN may refer to a network that operates in accordance with any of a plurality of different types of Institute of Electrical and Electronics Engineers (IEEE) 802.11 wireless communication protocols. The example embodiments may be applied as an upgrade to any 802.11 communication protocols, including but not limited to 802.11a, 802.11b, 802.11g, 802.11n, 802.11ac, 802.11ax, 802.11bn, 802.11-24, etc. The WLAN may operate in several different frequency bands of the radio frequency (RF) spectrum. For example, the operating frequencies may include but are not limited to, the 900 megahertz (MHz), 2.4 gigahertz (GHz), 3.6 GHz, 4.9 GHz, 5 GHz, 5.9 GHz, 6 GHz, 60 GHz bands, etc. Each band may include a plurality of channels. However, any reference to WLAN, a particular communication protocol or a particular frequency band is for illustrative purposes. The example embodiments apply to any type of network that supports packet-based communication over multiple links between devices.

The example embodiments are described with regard to a multilink station (STA) communicating with a multilink access point (AP). The STA may also be referred to as a client. However, the example embodiments may apply to wireless communications between any two multilink devices. For example, the example embodiments may be applied to communications between two multilink STAs in a peer-to-peer communication arrangement.

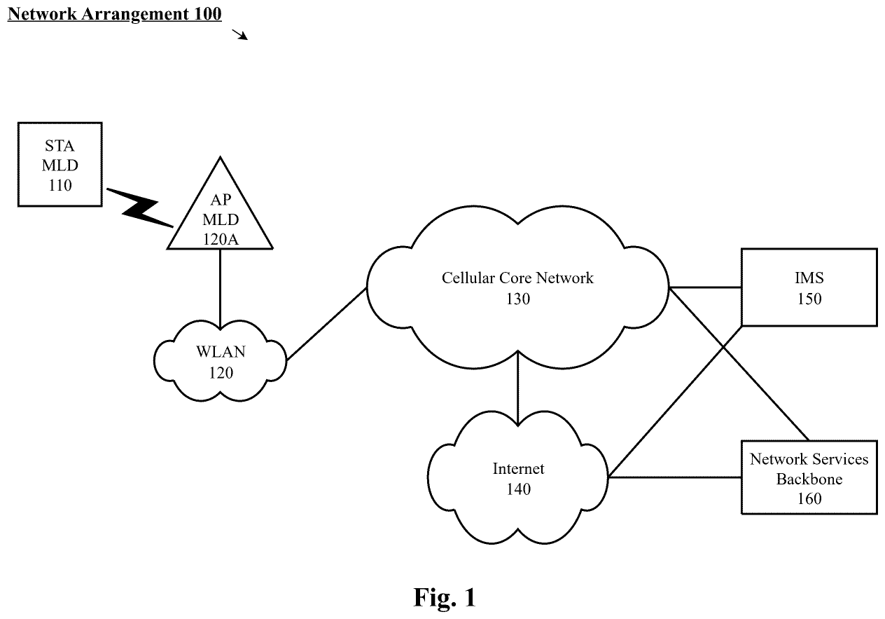

FIG. 1 shows an example network arrangement 100 according to various example embodiments. The example network arrangement 100 includes a multilink STA 110. The STA 110 may be any type of electronic component that is configured to communicate via a network, e.g., mobile phones, tablet computers, desktop computers, smartphones, phablets, embedded devices, wearables, Internet of Things (IoT) devices, etc. An actual network arrangement may include any number of STAs being used by any number of users. Thus, the example of a single STA 110 is merely provided for illustrative purposes.

Further, the example network arrangement 100 includes a wireless local access network (WLAN) 120. However, the STA 110 may also communicate with other types of networks and the STA 110 may also communicate with networks over a wired connection. Therefore, the STA 110 may include a WLAN chipset to communicate with the WLAN 120 and any of a plurality of further chipsets to communicate with other types of networks (e.g., 5G new radio (NR) radio access network (RAN), Long-Term Evolution (LTE) RAN, Legacy RAN, etc.).

The WLAN 120 may include any type of wireless local area network (WiFi, Hot Spot, soft AP, IEEE 802.11 networks, etc.). The example embodiments are described with reference to the developing IEEE 802.11be communication protocol but are not limited to this protocol. WLANs may manage access to the network via any of a plurality of different hardware devices that are configured to send and/or receive traffic from STAs that are equipped with the appropriate WLAN chipset. In the example network arrangement 100, the STA 110 may connect to the WLAN 120 via a multilink access point (AP) 120A. However, reference to an AP is merely provided for illustrative purposes. The example embodiments may apply to any type of multilink device that manages access to a WLAN.

In addition to the WLAN 120, the network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of a cellular network. The cellular core network 130 also manages the traffic that flows between the cellular network and the Internet 140. The IMS 150 may be generally described as an architecture for delivering multimedia services to the STA 110 using the IP protocol. The IMS 150 may communicate with the cellular core network 130 and the Internet 140 to provide the multimedia services to the STA 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the STA 110 in communication with the various networks.

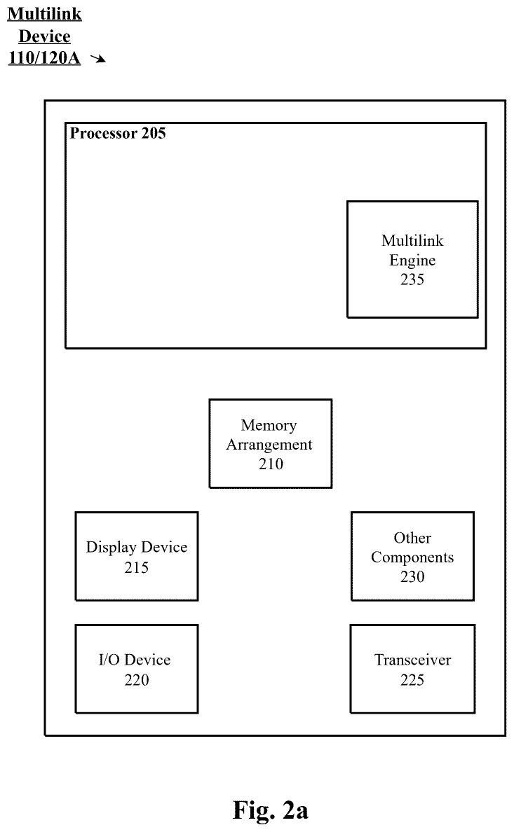

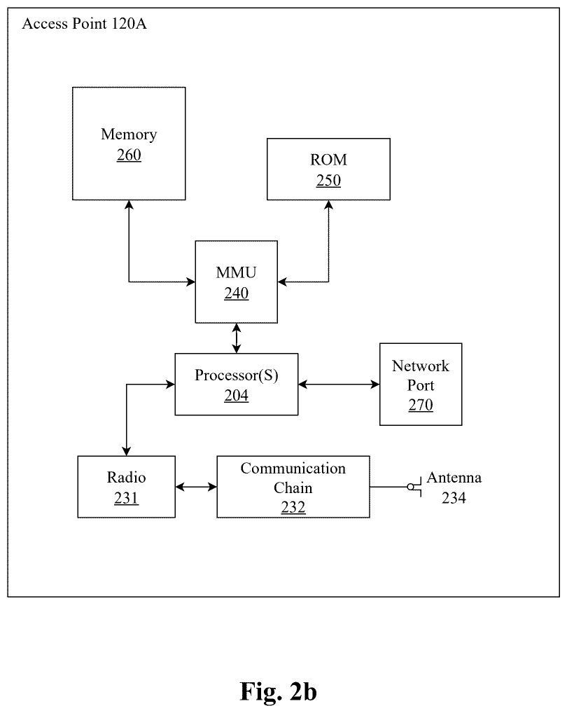

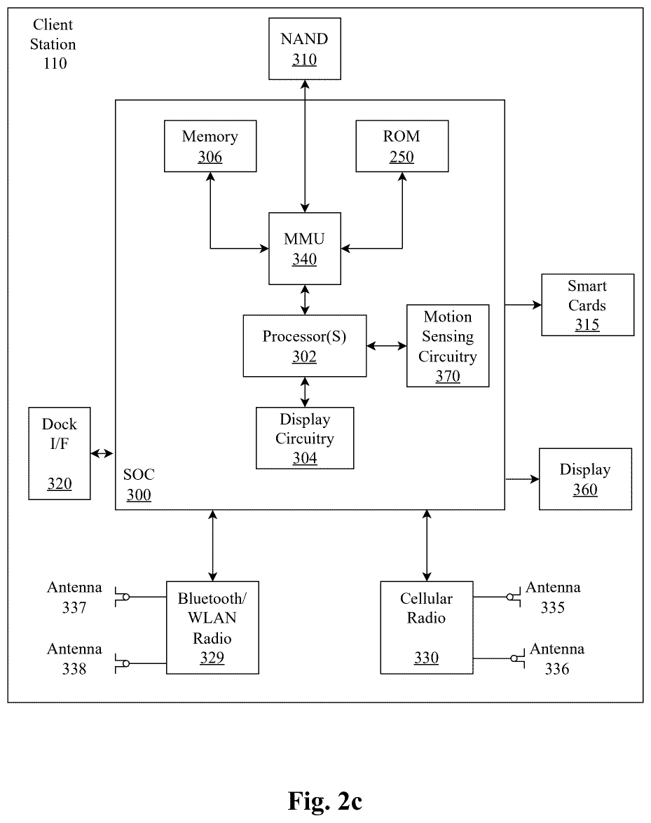

FIG. 2A shows an example multilink device 110/120A according to various example embodiments. That is, the multilink device described with respect to FIG. 2A may represent the STA 110 and/or the AP 120A. Those skilled in the art will understand that the STA 110 and the AP 120A may include the same components or may have some variation in the components between the devices. The multilink device 110/120A will be described with regard to the network arrangement 100 of FIG. 1. The multilink device 110/120A may represent any electronic device and may include a processor 205, a memory arrangement 210, a display device 215, an input/output (I/O) device 220, a transceiver 225, and other components 230. The other components 230 may include, for example, an audio input device, an audio output device, a battery, a constant power supply, a data acquisition device, ports to electrically connect the multilink device 110/120A to other electronic devices, sensors to detect conditions of the multilink device 110/120A, etc.

The processor 205 may be configured to execute a plurality of engines of the multilink device 110/120A. For example, the processor 205 may execute a multilink engine 235. The multilink engine 235 may perform various functionalities associated with the multilink communications for the multilink device 110/120A. The multilink engine 235 being an application (e.g., a program) executed by the processor 205 is only an example. The functionality associated with the fast link switch engine 235 may also be represented as a separate incorporated component of the multilink device 110/120A or may be a modular component coupled to the multilink device 110/120A, e.g., an integrated circuit with or without firmware. For example, the integrated circuit may include input circuitry to receive signals and processing circuitry to process the signals and other information. The engine may be embodied as one application or separate applications. In addition, in some multilink devices 110/120A, the functionality described for the processor 205 is split among two or more processors such as a baseband processor and an applications processor. The example embodiments may be implemented in any of these or other configurations of a multilink device 110/120A.

The memory arrangement 210 may be a hardware component configured to store data related to operations performed by the multilink device 110/120A. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the WLAN 120. Accordingly, the transceiver 225 may operate on a variety of different frequencies or channels (e.g., set of consecutive frequencies) as described above. As will be described in greater detail below, the transceiver 225 may include multiple radios.

FIG. 2B shows an example block diagram of an access point (AP) 112, which may be one possible exemplary implementation of the device AP MLD 120A illustrated in FIGS. 1 and 2. The block diagram of the AP of FIG. 2B is only one example of a possible system. As shown, the AP 112 may include processor(s) 204 which may execute program instructions for the AP 112. The processor(s) 204 may also be coupled (directly or indirectly) to memory management unit (MMU) 240, which may be configured to receive addresses from the processor(s) 204 and to translate those addresses to locations in memory (e.g., memory 260 and read only memory (ROM) 250) or to other circuits or devices.

The AP 112 may include at least one network port 270. The network port 270 may be configured to be coupled to a wired network and provide a plurality of devices, such as client station 110, access to the Internet. For example, the network port 270 (and/or an additional network port) may be configured to be coupled to a local network, such as a home network or an enterprise network. For example, port 270 may be an Ethernet port. The local network may provide connectivity to additional networks, such as the Internet.

The AP 112 may include at least one antenna 234 and may be further configured to communicate with any mobile device via wireless communication circuitry 231. The antenna 234 communicates with the wireless communication circuitry 231 via communication chain 232. Communication chain 232 may include one or more receive chains, one or more transmit chains or both. The wireless communication circuitry 231 may be configured to communicate via Wi-Fi or WLAN, e.g., 802.11. The wireless communication circuitry 231 may also, or alternatively, be configured to communicate via various other wireless communication technologies, including, but not limited to, Long-Term Evolution (LTE), LTE Advanced (LTE-A), Global System for Mobile (GSM), Wideband Code Division Multiple Access (WCDMA), CDMA2000, etc., for example when the AP is co-located with a base station in case of a small cell, or in other instances when it may be desirable for the AP 112 to communicate via various different wireless communication technologies.

FIG. 2C shows an example simplified block diagram of a client station, which may be one possible example implementation of the STA MLD 110 illustrated in FIGS. 1 and 2. According to embodiments, client station 110 may be a user equipment (UE) device, a mobile device or mobile station, and/or a wireless device or wireless station. As shown, the client station 110 may include a system on chip (SOC) 300, which may include portions for various purposes. The SOC 300 may be coupled to various other circuits of the client station 110. For example, the client station 110 may include various types of memory (e.g., including NAND flash 310), a connector interface (I/F) (and/or dock) 320 (e.g., for coupling to a computer system, dock, charging station, etc.), the display 360, cellular communication circuitry (e.g., cellular radio) 330 such as for 5G NR, LTE, GSM, etc., and short to medium range wireless communication circuitry (e.g., Bluetooth™/WLAN radio) 329 (e.g., Bluetooth™ and WLAN circuitry). The client station 110 may further include one or more smart cards 315 that incorporate SIM (Subscriber Identity Module) functionality, such as one or more UICC(s) (Universal Integrated Circuit Card(s)). The cellular communication circuitry 330 may be coupled to one or more antennas, such as antennas 335 and 336 as shown. The short to medium range wireless communication circuitry 329 may also be coupled to one or more antennas, such as antennas 337 and 338 as shown. Alternatively, the short to medium range wireless communication circuitry 329 may couple to the antennas 335 and 336 in addition to, or instead of, coupling to the antennas 337 and 338. The short to medium range wireless communication circuitry 329 may include multiple receive chains and/or multiple transmit chains for receiving and/or transmitting multiple spatial streams, such as in a multiple-input multiple output (MIMO) configuration. Some or all components of the short to medium range wireless communication circuitry 329 and/or the cellular communication circuitry 330 may be used for ranging communications, e.g., using WLAN, Bluetooth, and/or cellular communications.

As shown, the SOC 300 may include processor(s) 302, which may execute program instructions for the client station 110 and display circuitry 304, which may perform graphics processing and provide display signals to the display 360. The SOC 300 may also include motion sensing circuitry 370 which may detect motion of the client station 110, for example using a gyroscope, accelerometer, and/or any of various other motion sensing components.

The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, cellular communication circuitry 330, short range wireless communication circuitry 329, connector interface (I/F) 320, and/or display 360. The MMU 340 may be configured to perform memory protection and page table translation or set up. In some embodiments, the MMU 340 may be included as a portion of the processor(s) 302.

As previously mentioned, 802.11be introduced the Stream Classification Service with QoS Characteristics (SCS+QoS Char.) protocol to enable a client to request the AP to trigger the client for UL based on a minimum/maximum service interval and a minimum data rate. Requesting a large data rate on a long term basis in the SCS agreement may lead to unnecessary padding (dumping of bits) and power consumption. However, due to channel conditions or dynamic change in the application data size with variable bit rate codec during a QoS session, allocated UL resources may not be sufficient and may lead to a buffer build up. A temporary buffer build up requires more UL resources to be allocated by the AP to meet the delay bound. A client that is operating under Multi-User Enhanced Distributed Channel Access (MU EDCA) may not be able to access the channel at the proper time, and if the AP does not trigger the remaining buffered data, a client may fail the delay bound, causing a glitch in the data.

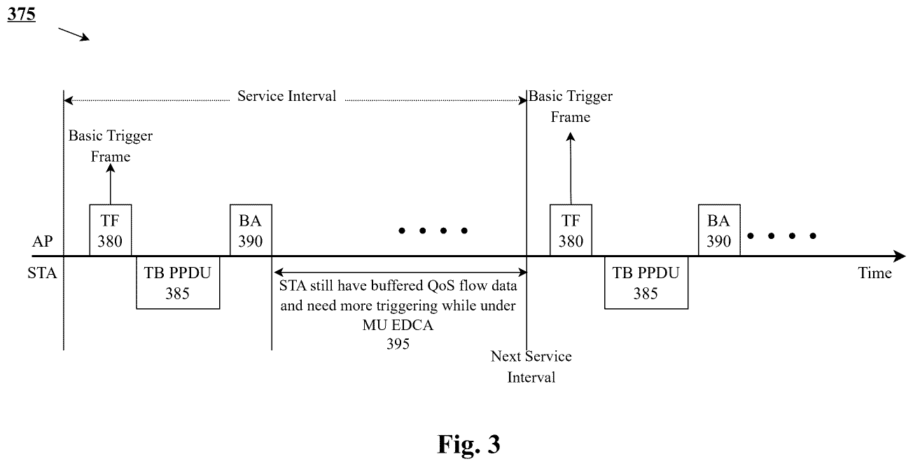

An example of this may be seen in FIG. 3. FIG. 3 shows an example timing diagram of transmissions between an access point (AP) MLD and a multilink station (STA) MLD illustrating how a station (client) operating under MU EDCA has buffered data which will not be sent within the delay bound because an access point does not trigger additional resources for the remaining data in the station's buffer according to various example embodiments. In the timing diagram 375, the AP transmits a basic trigger frame (380). Upon receipt, the STA transmits data sent in a trigger-based physical layer convergence protocol (PLCP) protocol data unit (TB PPDU) (385). After receipt of the data, the AP transmits a block acknowledgement (BA) (390). However, the STA may still have buffered QoS flow data and needs additional triggering while under MU EDCA (395), which will not occur before the delay bound (end of the service interval) without the additional triggering. The AP may use a large MU EDCA Timer (e.g., 64 TUs) that is much larger than the delay bound of the application. In this case, applications with tight delay bounds (e.g., <=10 milliseconds (msec)) are more prone to such failures.

Enhancements to the SCS to meet the delay bound in a wider range of applications, including video communication sessions, would be beneficial.

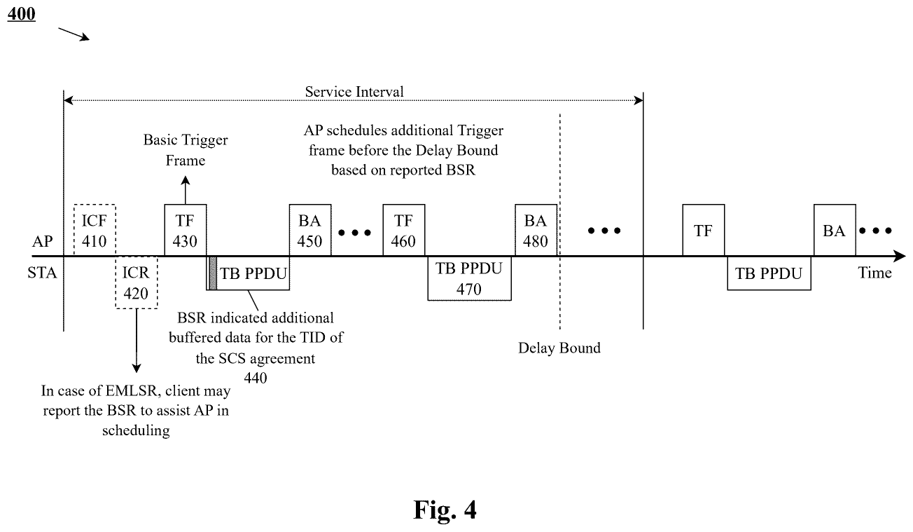

One proposed method to enhance the SCS to meet the delay bound in a wider range of situations, including but not limited to the one mentioned above, will be discussed below. FIG. 4 is an example timing diagram of transmissions between an access point (AP) MLD and a multilink station (STA) MLD in an enhanced method of performing SCS to meet a delay bound according to various example embodiments. Under an SCS agreement, a client (station) requests in the SCS agreement a commitment from the AP for more triggering (beyond a minimum data rate) during an SCS agreement based on a reported Buffer Status Report (BSR). The goal is to meet the delay bound before the upcoming service interval if the client reports more data in the queue size for the Traffic Identifier (TID) of the SCS agreement, which may be defined with multiple TIDs. An AP that accepts such request makes a promise, on a long-term basis, to trigger the client sufficiently until the AP depletes the reported queue size for the TID of the SCS agreement. The AP may trigger the client more for the unacknowledged data that is reported in the BSR.

Referring to FIG. 4, in case of Enhanced Multi-Link Single-Radio (EMLSR) operation, the method 400 is performed as follows: after the initial control frame (ICF) (410) from the AP, in the response (ICR) (420), the client (station) may report the BSR to the AP to assist the AP in scheduling. After the trigger frame from the AP (430), the client transmits data, e.g., TB PPDU (440). The AP transmits a BA upon receipt of the data (450). If the BSR indicates that there is additional buffered data in the queue for the TID of the SCS agreement, the AP schedules one or more additional trigger frame(s) (460) before the end of the delay bound based on the reported BSR. The client may then transmit additional data (TB PPDU) (470) before the end of the delay bound, which is acknowledged by the AP in a BA (480). In some example embodiments, the BSR may be an enhanced BSR which includes additional information to help the AP in scheduling. Further, in some embodiments, there may be other opportunities to report to the AP how much data is to be transmitted, how much data is still in the queue, and/or how much data is remaining. Regardless of how the AP receives a report regarding the data, if the AP has accepted the commitment from the client for more triggering, then the AP schedules one or more additional trigger frame(s) before the end of the delay bound so that all of the data is sent by the end of the data bound.

The above-described sequence may be part of an EMLSR sequence where an AP first transmits a Buffer Status Report Poll (BSRP) Trigger frame and the clients use the BSR to report to the AP the buffered data size so that the AP may adapt the allocation for UL data transmission accordingly.

To accomplish the enhanced method of performing SCS to meet a delay bound discussed above where the client requests in the SCS agreement a commitment from the AP for more triggering (beyond the minimum data rate) during an SCS agreement based on a reported Buffer Status Report (BSR), and an AP that accepts such request makes a promise, on a long-term basis, to trigger the client sufficiently until the AP depletes the reported queue size for the TID of the SCS agreement, a new field may be added to the QoS Characteristics element.

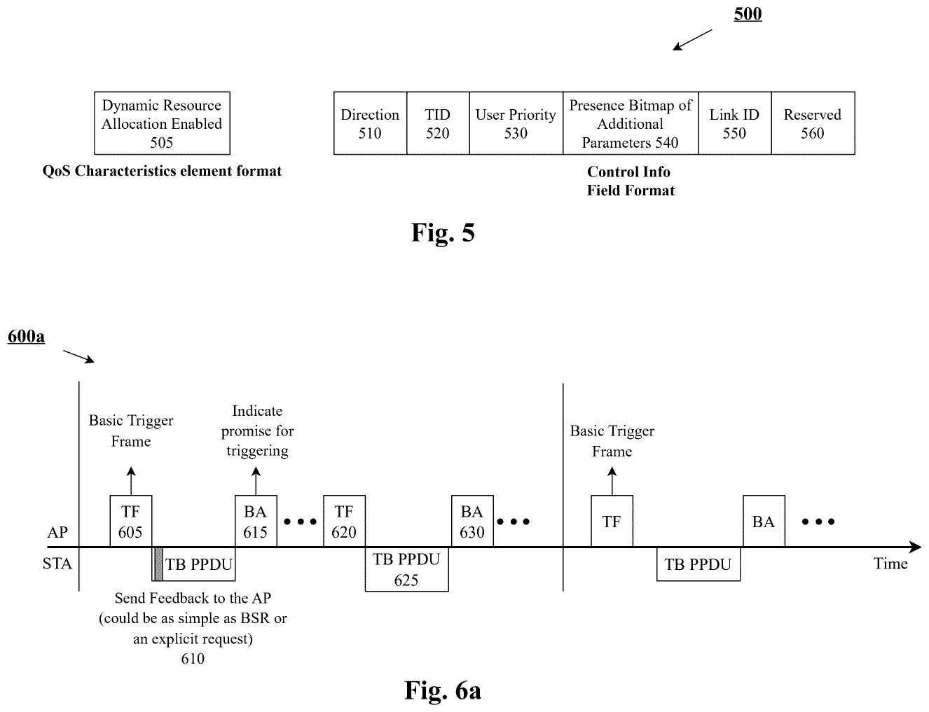

FIG. 5 shows an example QoS Characteristics element 500 with a new field 505 (Dynamic Resource Allocation Enabled) according to various example embodiments. The example QoS Characteristics element may include a direction field 510, a TID field 520, a user priority field 530, a control info field 540 which may include a Presence Bitmap of Additional Parameters, a link ID field 550, and a reserved field 560. This new Dynamic Resource Allocation Enabled field 505 may be part of the Presence Bitmap of Additional Parameters of the control info field 540 in one embodiment. In various embodiments, the Dynamic Resource Allocation Enabled field 505 may be one (1) bit or more than one bit.

For such type of SCS agreements, other SCS parameters such as the Delay Bound field and Delay Bounded Burst Size fields may be leveraged to provide the AP with an expectation of the Maximum Burst Size to expect from the client (long term indication). Another way may be to provide dynamic information to the AP about the buffered data or required data rate (e.g., using a MAC frame header such as A-Control field and/or Management level signaling). One advantage of providing the dynamic information is that it is independent of the client's knowledge, and as traffic changes, the amount of data or required data rate may become more accurate. The dynamic resource allocation discussed above may be extended as well for the downlink (DL) case.

A second example mechanism may be used to enhance the SCS to meet the delay bound in a wider range of situations. This second mechanism may be used alone or together with the first method discussed above. This mechanism may be a short-term mechanism and may be referred to as transmission opportunity (TXOP) and service interval level enhancements.

A short-term mechanism is proposed that aims at adjusting the allocated UL resources to a client to address the temporary queue build up at the client during an SCS agreement. This may happen temporarily where the AP triggering is not sufficient and QoS flow(s) start suffering from longer delays and fail to meet the delay bound (e.g., 10 msecs). Thus, the goal is to meet the delay bound of the QoS flow(s) in such scenarios. The assumption is that the client has an existing SCS agreement (including the corresponding delay bound in the SCS) with the AP for such QoS flow(s).

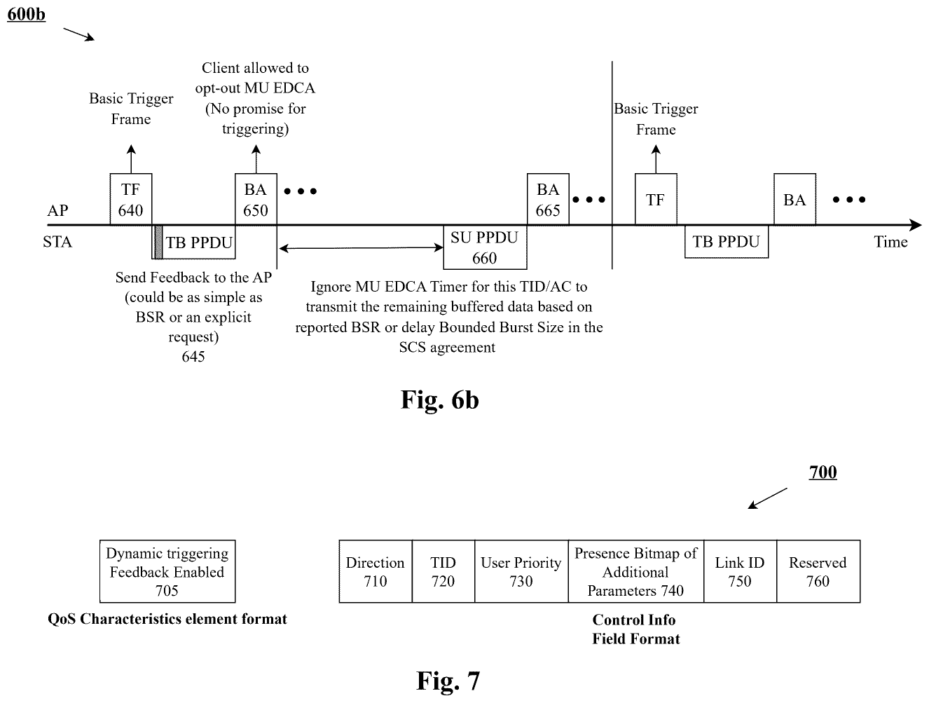

To address the temporary buffer build up, the following is proposed under an SCS agreement, as seen in FIGS. 6A and 6B. FIGS. 6A and 6B are example timing diagrams of transmissions between an access point (AP) MLD and a multilink station (STA) MLD in another enhanced method of performing SCS to meet a delay bound according to various example embodiments. In the method 600A of FIG. 6A, after the basic trigger frame is transmitted by the AP (605), the client transmits data and a request (610) to the AP for more triggering (beyond minimum data rate) before the upcoming service interval to meet the delay bound. This request may be feedback sent to the AP, or a BSR, or it may be an explicit request for more triggering. In some example embodiments, this request 610 may be a regular BSR similar to baseline or it may be through 802.11bn BSR enhancements (with an explicit more triggering request) to indicate the amount of data buffered at the client for the TID of the SCS agreement. This request 610 may be sent along with the data sent in the trigger-based physical layer convergence protocol (PLCP) protocol data unit (TB PPDU) or in the single user (SU) PPDU (e.g., other TIDs).

Upon receipt of the request for more triggering, the AP may do either of two operations. In a first case, as seen in FIG. 6A, the AP may include a feedback to promise the client it will commit to more triggering (in block acknowledgement (BA) or Multi-TID block acknowledgment (M-BA)) (615). That is, the AP responds with a promise or commitment for additional triggering before the upcoming service interval. In this case, since the AP promises to trigger the client before the upcoming service interval, the client continues to operate normally under MU EDCA. Another trigger frame will be sent (620). Upon receipt of the additional trigger frame 620, the client may transmit additional data (TB PPDU) (625). The AP will transmit a BA upon receipt of the additional data (630). Additional trigger frames may be sent before the end of the delay bound to allow the client to transmit all of its buffered data to satisfy the QoS.

Alternatively, in the second case, as seen in the method 600B of FIG. 6B, after the basic trigger frame is transmitted by the AP (640), the client transmits data and a request (645) to the AP for more triggering (beyond minimum data rate) before the upcoming service interval to meet the delay bound. In the second case, the AP does not promise to commit to additional triggering but sends an indication (in BA or M-BA) to allow the client to opt-out of the MU EDCA timer for the TID of the SCS agreement (650). In this case, the client is allowed to contend for channel access using regular EDCA parameters for that TID, even if the MU EDCA timer is greater than zero for the access channel (AC) that corresponds to the TID of the SCS agreement, to transmit the reported traffic (via SU PPDU) and meet the agreed delay bound (660). The AP will send a BA upon receipt of the data (665). That is, in this case, the client may ignore the MU EDCA timer for this TID/AC to transmit the remaining buffered data based on the reported BSR or Delay Bounded Burst Size in the SCS agreement. Higher priority is given to the client in this situation. The client will honor the MU EDCA Timer again after transmitting the SU PPDU for any remaining QoS flow buffered data. Scheduling of subsequent trigger frames is not affected in this case; the AP continues to schedule the UL triggering based on the SCS service intervals. Note that if UL MU Data Disable in Operating Mode (OM) Control (A-Control) is used, a station (client) may not get access to the channel to enable UL triggering again before the upcoming service interval (e.g., 10-20 ms) and hence does not get scheduled for the subsequent trigger frame.

To control the behavior of the AP and client in the above method disclosed in FIGS. 6A and 6B, a new field is defined in the SCS Request and Response frame to enable this mechanism, as seen in FIG. 7. FIG. 7 shows an example QoS Characteristics element 700 with a new field 705 (Dynamic Triggering Feedback Enabled) according to various example embodiments. The example QoS Characteristics element 700 may include a direction field 710, a TID field 720, a user priority field 730, a control info field 740 which may include a Presence Bitmap of Additional Parameters, a link ID field 750, and a reserved field 570. This new Dynamic Triggering Feedback Enabled field 705 may be part of the Presence Bitmap of Additional Parameters of the control info field 740 in one embodiment. In various embodiments, the Dynamic Triggering Feedback Enabled field 705 may be one (1) bit or more than one bit.

If the AP accepts an SCS agreement with a Dynamic Triggering Feedback Enabled set to 1, the second mechanism discussed above with respect to FIGS. 6A and 6B is enabled to assist the client in meeting the agreed delay bound. Also, additional rules may be added to limit related behavior corresponding to the second case above. For example, a client STA is limited to transmitting the remaining buffered data subject to a Delay Bounded Burst Size that is already part of the 802.11be QoS Characteristics element, or subject to the reported BSR for that TID.

In addition to the above disclosed mechanisms, it may be helpful to allow additional TID(s) for an AC (such as AC_VO (voice) and AC_VI (video)) during an SCS agreement. This helps the AP to isolate other traffic from the SCS flows and be able to trigger the client to deplete the buffers for the TID(s) of an SCS agreement. Also, the additional TID(s) may also help to streamline the reception of those QoS flows and reduce reorder buffer delays. If a client requests in the SCS Request frame the additional TID(s), one or more TID(s) may be dynamically assigned to a particular AC. If the AP accepts the additional TID(s) in the UL or DL, a separate BA agreement(s) may be set up for the additional TIDs. The same additional TID may be used for bidirectional flows to help the AP isolate other traffic from the traffic of the SCS flows and enhance the delivery of the DL traffic for the TID(s) of an SCS agreement.

In summary, disclosed herein are proposed mechanisms to address the issue where an 802.11 client may have a temporary surge in the buffer size for QoS flows due to variable bit rate in application during an SCS agreement. For QoS flows with tight delay bounds (<=10 ms), a client operating under MU EDCA mode may start failing the delay bound due to insufficient UL triggering by the AP.

Two different mechanisms (SCS based, and TXOP/Service Interval based) are disclosed to enhance the QoS by enabling the client to be triggered more, or for the AP to allow the client to opt-out of the MU EDCA mode for a TID to meet the delay bound of an SCS agreement while keeping the triggering cadence. Necessary rules are proposed to control the usage of such mechanisms by the AP. Using these proposed mechanisms will allow a client having an SCS agreement to meet the delay bound in a wider range of applications, including video communication sessions.

### EXAMPLES

In a first example, a method, comprising generating, for transmission to an access point (AP) under a Stream Classification Service (SCS) agreement, a request for a commitment for triggering beyond a minimum data rate specified in the SCS agreement based on a buffer status report (BSR), processing, based on signaling received from the AP, one or more trigger frames pursuant to the commitment and generating, for transmission to the AP, data in response to the one or more trigger frames.

In a second example, the method of the first example, wherein the data is included in a trigger-based physical layer convergence protocol (PLCP) protocol data unit (TB PPDU).

In a third example, the method of the first example, further comprising transmitting the BSR to the AP as part of the request for the commitment.

In a fourth example, the method of the third example, wherein the BSR is configured to indicate additional buffered data for a traffic identifier (TID) of the SCS agreement.

In a fifth example, the method of the first example, further comprising processing, based on one or more signals received from the AP, a Buffer Status Report Poll (BSRP) trigger frame as part of an Enhanced Multi-Link Single-Radio (EMLSR) sequence and generating, in response to the BSRP trigger frame, a BSR configured to report to the AP a buffered data size to allow the AP to adapt allocation of resources for uplink data transmission.

In a sixth example, the method of the first example, further comprising, prior to the request for the commitment, generating signaling comprising a Quality of Service (QoS) element comprising a Dynamic Resource Allocation Enabled field.

In a seventh example, the method of the sixth example, wherein the signaling further comprises one or more of a Delay Bound field, a Delay Bounded Burst Size field, or a Maximum Burst Size field, wherein the one or more of the Delay Bound field, the Delay Bounded Burst Size field, or the Maximum Burst Size field are configured to provide an indication to the AP of an amount of data to be transmitted and a maximum burst size to expect.

In an eighth example, the method of the sixth example, wherein the signaling further comprises a Medium Access Control (MAC) header including dynamic information indicating an amount of the data to be transmitted or a requested data rate.

In a ninth example, a processor configured to perform any of the methods of the first through eighth examples.

In a tenth example, a wireless communication device configured to perform any of the methods of the first through eighth examples.

In an eleventh example, a method, comprising generating, in response to determining that a temporary data buffer build up has occurred, for transmission to an access point (AP) under a Stream Classification Service (SCS) agreement, a request for triggering beyond a minimum data rate specified in the SCS agreement, the triggering being before an upcoming service interval in order to satisfy a delay bound, processing, based on signaling received from the AP, feedback in response to the request for triggering and generating, for transmission to the AP, data in response to the feedback.

In a twelfth example, the method of the eleventh example, wherein the request for triggering comprises a Buffer Status Report (BSR) indicating an amount of data buffered at the apparatus for a traffic identifier (TID) of the SCS agreement.

In a thirteenth example, the method of the eleventh example, wherein the request for triggering comprises Buffer Status Report (BSR) enhancements associated with 802.11bn.

In a fourteenth example, the method of the eleventh example, wherein the request is sent together with data sent by the apparatus in a trigger-based physical layer convergence protocol (PLCP) protocol data unit (TB PPDU) or a single user (SU) PPDU.

In a fifteenth example, the method of the eleventh example, wherein the feedback received from the AP comprises a commitment to provide additional triggering before the upcoming service interval.

In a sixteenth example, the method of the fifteenth example, wherein the feedback is received in a block acknowledgement (BA) or a Multi-Traffic-Identifier block acknowledgement (m-BA).

In a seventeenth example, the method of the eleventh example, wherein the apparatus is operating using multi-user enhanced distributed channel access (MU EDCA), and wherein the feedback comprises an indication allowing the apparatus to opt out of a MU EDCA timer for a traffic identifier (TID) of the SCS agreement.

In an eighteenth example, the method of the seventeenth example, wherein the apparatus contends for channel access using an EDCA parameter for the TID, even when the MU EDCA timer is greater than zero for the access channel that corresponds to the TID of the SCS agreement, to transmit remaining buffered data to satisfy the delay bound.

In a nineteenth example, the method of the eighteenth example, further comprising honoring the MU EDCA timer after the data for a remaining Quality of Service (QoS) flow buffered data has been transmitted.

In a twentieth example, the method of the eighteenth example, wherein the remaining buffered data is generated for transmission subject to a Delay Bounded Burst Size that is part of the SCS agreement or that is configured as part of a Quality of Service (QoS) element received from the AP and/or a reported Buffer Status Report (BSR) for the TID.

In a twenty first example, the method of the eleventh example, further comprising, prior to the request for triggering, generating signaling to the AP under the SCS agreement, the signaling comprising a Quality of Service (QoS) element comprising a Dynamic Triggering Feedback Enabled field.

In a twenty second example, the method of the twenty first example, wherein the signaling is associated with negotiation of one or more additional Traffic Identifiers (TIDs) for an access channel during the SCS agreement.

In a twenty third example, a processor configured to perform any of the methods of the eleventh through twenty second examples.

In a twenty fourth example, a wireless communication device configured to perform any of the methods of the eleventh through twenty second examples.

In a twenty fifth example, a method, comprising processing, based on signaling received from a client under a Stream Classification Service (SCS) agreement, a request for a commitment for triggering beyond a minimum data rate specified in the SCS agreement during the SCS agreement based on a reported buffer status report (BSR) and, in response to agreeing to a commitment to provide triggering, generating one or more trigger frames pursuant to the commitment.

In a twenty sixth example, the method of the twenty fifth example, further comprising generating, for transmission to the client, an indication of acceptance of the commitment to provide triggering to the client.

In a twenty seventh example, the method of the twenty fifth example, further comprising generating, for transmission to the client, one or more additional trigger frames until a reported queue size for a traffic identifier (TID) of the SCS agreement satisfies a predetermined threshold.

In a twenty eighth example, the method of the twenty fifth example, further comprising generating, for transmission to the client, one or more additional trigger frames based on unacknowledged data reported in the BSR.

In a twenty ninth example, the method of the twenty fifth example, further comprising generating, for transmission to the client, a Buffer Status Report Poll (BSRP) trigger frame as part of an Enhanced Multi-Link Single-Radio (EMLSR) sequence and processing, based on one or more signals received from the client in response to the BSRP trigger frame, a BSR configured to report a buffered data size to allow for adapting allocation of resources for uplink data transmission.

In a thirtieth example, the method of the twenty fifth example, further comprising processing the BSR from the client, wherein the BSR indicates additional buffered data for a traffic identifier (TID) of the SCS agreement.

In a thirty first example, the method of the twenty fifth example, further comprising, prior to the request for the commitment, processing signaling comprising a Quality of Service (QoS) element comprising a Dynamic Resource Allocation Enabled field.

In a thirty second example, the method of the thirty first example, wherein the signaling further comprise one or more of a Delay Bound field, a Delay Bounded Burst Size field, or a Maximum Burst Size field, wherein the one or more of the Delay Bound field, the Delay Bounded Burst Size field, or the Maximum Burst Size field are configured to provide an indication to the AP of an amount of data to be transmitted and a maximum burst size to expect.

In a thirty third example, the method of the thirty first example, wherein the signaling further comprises a Medium Access Control (MAC) header including dynamic information to the AP indicating an amount of the data to be transmitted or a requested data rate.

In a thirty fourth example, a processor configured to perform any of the methods of the twenty fifth through thirty third examples.

In a thirty fifth example, an access point configured to perform any of the methods of the twenty fifth through thirty third examples.

In a thirty sixth example, a method, comprising processing, based on signaling received from a client under a Stream Classification Service (SCS) agreement, an indication that a temporary data buffer build up has occurred and a request for triggering beyond a minimum data rate specified in the SCS agreement, the triggering occurring before an upcoming service interval to satisfy a delay bound and, in response to the request for triggering, generating feedback configured to allow the client to transmit data in response to the feedback.

In a thirty seventh example, the method of the thirty sixth example, wherein the request for triggering comprises a Buffer Status Report (BSR) configured to indicate an amount of data buffered at the client for a traffic identifier (TID) of the SCS agreement.

In a thirty eighth example, the method of the thirty sixth example, wherein the request for triggering comprises a Buffer Status Report (BSR) enhancement associated with 802.11bn.

In a thirty ninth example, the method of the thirty sixth example, wherein the request is received from the client together with data sent by the client in a trigger-based physical layer convergence protocol (PLCP) protocol data unit (TB PPDU) or a single user (SU) PPDU.

In a fortieth example, the method of the thirty sixth example, further comprising generating a commitment to provide additional triggering before the upcoming service interval.

In a forty first example, the method of the fortieth example, wherein the feedback is transmitted in a block acknowledgement (BA) or a Multi-Traffic-Identifier block acknowledgement (m-BA).

In a forty second example, the method of the thirty sixth example, wherein the client is operating using multi-user enhanced distributed channel access (MU EDCA), and wherein the feedback comprises an indication allowing the client to opt out of a MU EDCA timer for a traffic identifier (TID) of the SCS agreement.

In a forty third example, the method of the forty second example, wherein the feedback includes an indication allowing the client to contend for channel access using an EDCA parameter for the TID, even when the MU EDCA timer is greater than zero for the access channel that corresponds to the TID of the SCS agreement, to transmit remaining buffered data and satisfy the delay bound.

In a forty fourth example, the method of the forty third example, further comprising generating, for transmission to the client, a Quality of Service (QoS) element comprising a Delay Bounded Burst Size or a reported Buffer Status Report (BSR) for the TID, wherein the Delay Bounded Burst Size or the reported BSR limits how the client transmits the remaining buffered data.

In a forty fifth example, the method of the thirty sixth example, further comprising, prior to the request for triggering, processing signaling from the client under the SCS agreement comprising a Quality of Service (QoS) element, the QoS element including a Dynamic Triggering Feedback Enabled field.

In a forty sixth example, the method of the forty fifth example, wherein the signaling includes negotiation of one or more additional Traffic Identifiers (TIDs) for an access channel during the SCS agreement.

In a forty seventh example, a processor configured to perform any of the methods of the thirty sixth through forty sixth examples.

In a forty eighth example, an access point configured to perform any of the methods of the thirty sixth through forty sixth examples.

In a forty ninth example, a wireless communication system comprising a client and an access point (AP), wherein the client comprises transceiver circuitry to transmit to an access point (AP), under a Stream Classification Service (SCS) agreement, a request for a commitment for triggering beyond a minimum data rate specified in the SCS agreement based on a reported buffer status report (BSR) and the AP comprises processing circuitry configured to cause transceiver circuitry to transmit an indication to the client that the AP has accepted the commitment to provide triggering, and pursuant to the commitment, cause the transceiver circuitry to send a trigger frame to the client, wherein the processing circuitry in the client is configured to cause transceiver circuitry to transmit data in response to the trigger frame received from the AP.

In a fiftieth example, a wireless communication system comprising a client and an access point (AP), wherein the client comprises processing circuitry that is configured to cause transceiver circuitry to transmit, in response to a determination that a data buffer build up has occurred for the client, a request to the AP, under a Stream Classification Service (SCS) agreement, for triggering beyond a minimum data rate specified in the SCS agreement, the triggering occurring before an upcoming service interval in order to meet a delay bound and the AP comprises processing circuitry to cause transceiver circuitry to send feedback to the client in response to the request for triggering, wherein the processing circuitry in the client is configured to cause transceiver circuitry to transmit data in response to and based on the feedback received from the AP.

In a fifty first example, the wireless communication system of the fiftieth example, wherein the feedback received from the AP comprises a commitment to provide additional triggering before the upcoming service interval.

In a fifty second example, the wireless communication system of the fiftieth example, wherein the client is operating using multi-user enhanced distributed channel access (MU EDCA), and wherein the feedback comprises an indication allowing the client to opt out of a MU EDCA timer for a traffic identifier (TID) of the SCS agreement, wherein the processing circuitry of the client is configured to contend for channel access using regular EDCA parameters for the TID, even when the MU EDCA timer is greater than zero for an access channel that corresponds to the TID of the SCS agreement, to transmit remaining buffered data and satisfy the delay bound.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. In a further example, the example embodiments of the above-described method may be embodied as a program containing lines of code stored on a non-transitory computer readable storage medium that, when compiled, may be executed on a processor or microprocessor.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE, client, or AP) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICs. In other embodiments, the present invention may be realized using one or more programmable hardware elements such as FPGAS.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry coupled to memory, the processing circuitry configured to:
generate, for transmission to an access point (AP) under a Stream Classification Service (SCS) agreement, a request for a commitment for triggering beyond a minimum data rate specified in the SCS agreement based on a buffer status report (BSR);
process, based on signaling received from the AP, one or more trigger frames pursuant to the commitment; and
generate, for transmission to the AP, data in response to the one or more trigger frames.

2. The apparatus of claim 1, wherein the data is included in a trigger-based physical layer convergence protocol (PLCP) protocol data unit (TB PPDU).

3. The apparatus of claim 1, wherein the processing circuitry is configured to cause transceiver circuitry to transmit the BSR to the AP as part of the request for the commitment.

4. The apparatus of claim 3, wherein the BSR is configured to indicate additional buffered data for a traffic identifier (TID) of the SCS agreement.

5. The apparatus of claim 1, wherein the processing circuitry is configured to:
process, based on one or more signals received from the AP, a Buffer Status Report Poll (BSRP) trigger frame as part of an Enhanced Multi-Link Single-Radio (EMLSR) sequence; and
generate, in response to the BSRP trigger frame, a BSR configured to report to the AP a buffered data size to allow the AP to adapt allocation of resources for uplink data transmission.

6. The apparatus of claim 1, wherein the processing circuitry is configured to, prior to the request for the commitment, generate signaling comprising a Quality of Service (QoS) element comprising a Dynamic Resource Allocation Enabled field.

7. The apparatus of claim 6, wherein the signaling further comprises one or more of a Delay Bound field, a Delay Bounded Burst Size field, or a Maximum Burst Size field, wherein the one or more of the Delay Bound field, the Delay Bounded Burst Size field, or the Maximum Burst Size field are configured to provide an indication to the AP of an amount of data to be transmitted and a maximum burst size to expect.

8. The apparatus of claim 6, wherein the signaling further comprises a Medium Access Control (MAC) header including dynamic information indicating an amount of the data to be transmitted or a requested data rate.

9. An apparatus comprising processing circuitry coupled to memory, the processing circuitry configured to:
generate, in response to determining that a temporary data buffer build up has occurred, for transmission to an access point (AP) under a Stream Classification Service (SCS) agreement, a request for triggering beyond a minimum data rate specified in the SCS agreement, the triggering being before an upcoming service interval in order to satisfy a delay bound;
process, based on signaling received from the AP, feedback in response to the request for triggering; and
generate, for transmission to the AP, data in response to the feedback.

10. The apparatus of claim 9, wherein the request for triggering comprises a Buffer Status Report (BSR) indicating an amount of data buffered at the apparatus for a traffic identifier (TID) of the SCS agreement.

11. The apparatus of claim 9, wherein the request for triggering comprises Buffer Status Report (BSR) enhancements associated with 802.11bn.

12. The apparatus of claim 9, wherein the request is sent together with data sent by the apparatus in a trigger-based physical layer convergence protocol (PLCP) protocol data unit (TB PPDU) or a single user (SU) PPDU.

13. The apparatus of claim 9, wherein the feedback received from the AP comprises a commitment to provide additional triggering before the upcoming service interval.

14. The apparatus of claim 13, wherein the feedback is received in a block acknowledgement (BA) or a Multi-Traffic-Identifier block acknowledgement (m-BA).

15. The apparatus of claim 9, wherein the apparatus is operating using multi-user enhanced distributed channel access (MU EDCA), and wherein the feedback comprises an indication allowing the apparatus to opt out of a MU EDCA timer for a traffic identifier (TID) of the SCS agreement.

16. The apparatus of claim 15, wherein the apparatus contends for channel access using an EDCA parameter for the TID, even when the MU EDCA timer is greater than zero for the access channel that corresponds to the TID of the SCS agreement, to transmit remaining buffered data to satisfy the delay bound.

17. The apparatus of claim 16, wherein the processing circuitry is configured to honor the MU EDCA timer after the data for a remaining Quality of Service (QoS) flow buffered data has been transmitted.

18. The apparatus of claim 16, wherein the remaining buffered data is generated for transmission subject to:
a Delay Bounded Burst Size that is part of the SCS agreement or that is configured as part of a Quality of Service (QoS) element received from the AP; and/or
a reported Buffer Status Report (BSR) for the TID.

19. The apparatus of claim 9, wherein the processing circuitry is configured to, prior to the request for triggering, generate signaling to the AP under the SCS agreement, the signaling comprising a Quality of Service (QoS) element comprising a Dynamic Triggering Feedback Enabled field.

20. The apparatus of claim 19, wherein the signaling is associated with negotiation of one or more additional Traffic Identifiers (TIDs) for an access channel during the SCS agreement.
